(19) United States
(12) Patent Application Publication
(10) Pub. No.: US 2012/0296979 A1
(43) Pub. Date: Nov. 22, 2012

(54) CONFERENCE SYSTEM, CONFERENCE MANAGEMENT APPARATUS, METHOD FOR CONFERENCE MANAGEMENT, AND RECORDING MEDIUM

(75) Inventors: Toshimichi IWAI, Kitakatsuragi-gun (JP); Tomo Tsuboi, Itami-shi (JP); Kazumi Sawayanagi, Itami-shi (JP); Takehisa Yamaguchi, Ikoma-shi (JP); Akihiro Torigoshi, Amagasaki-shi (JP)

(73) Assignee: Konica Minolta Business Technologies, Inc., Chiyoda-ku (JP)

(21) Appl. No.: 13/472,911

(22) Filed: May 16, 2012

(30) Foreign Application Priority Data
May 19, 2011 (JP) 2011-112040

(51) Int. Cl. G06F 15/16

(52) U.S. Cl. 709/205

(57) ABSTRACT

A conference system comprises an operation input part for receiving an operation input for selecting a send object file, which is given by a user who is a conference participant, an image pickup part for picking up an image of said user, a motion detection part for detecting a predetermined motion of said user on the basis of a picked-up image obtained by said image pickup part, and a sending operation control part for sending said send object file under the condition that said predetermined motion is detected.

This application is based on Japanese Patent Application No. 2011-112040 filed on May 19, 2011, the contents of which are hereby incorporated by reference.

### BACKGROUND OF THE INVENTION

1. Field of the Invention

The present invention relates to a conference system and its relevant technique.

2. Description of the Background Art

There are well known conference systems for conducting conferences while transmitting and receiving images, voices, and the like among geographically distant sites. For such conference systems, there are techniques for transmitting various documents (in detail, data thereof) used in conferences from one (own) site to the other sites via a network or the like.

Japanese Patent Application Laid Open Gazette No. 2004-56551 (Patent Document 1), for example, discloses a technique in which when an instruction for transmitting documents to be sent is received, a sending file stored in a sending file folder is transmitted from a sender site to a destination site (or destination sites). Specifically, first, a user at the sender site stores a file which is selected as a document to be sent into a sending file folder. Then, the user at the sender site selects one of document (file) names displayed on a predetermined operation screen and clicks a send button, to thereby send a document (send object file) stored in the sending file folder to the destination site. By such a technique, it is possible to share a document among sites in a conference system since the document which only the sender site has is sent to destination sites (other sites).

In the technique of Patent Application Laid Open Gazette No. 2004-56551 (Patent Document 1), however, a very user-friendly user interface is not provided and the user interface has room for improvement.

### SUMMARY OF THE INVENTION

It is an object of the present invention to provide a conference system capable of providing a more user-friendly user interface and its relevant technique.

The present invention is intended for a conference system. According to a first aspect of the present invention, the conference system comprises an operation input part for receiving an operation input for selecting a send object file, which is given by a user who is a conference participant, an image pickup part for picking up an image of the user, a motion detection part for detecting a predetermined motion of the user on the basis of a picked-up image obtained by the image pickup part, and a sending operation control part for sending the send object file under the condition that the predetermined motion is detected.

According to a second aspect of the present invention, the conference system comprises a mobile data terminal, a conference management apparatus capable of communicating with the mobile data terminal, and an image pickup apparatus for picking up an image of a user who is a conference participant, and in the conference system of the present invention, the mobile data terminal has an operation input part for receiving an operation input for selecting a send object file, which is given by the user, and the conference management apparatus has a motion detection part for detecting a predetermined motion of the user on the basis of a picked-up image obtained by the image pickup apparatus and a sending operation control part for sending the send object file under the condition that the predetermined motion is detected.

The present invention is also intended for a conference management apparatus. According to a third aspect of the present invention, the conference management apparatus comprises a motion detection part for detecting a predetermined motion of a user who is a conference participant on the basis of a picked-up image of the user, and a sending operation control part for sending a send object file under the condition that the predetermined motion is detected, the send object file being selected by the user.

The present invention is further intended for a method for conference management. According to a fourth aspect of the present invention, the method for conference management comprises the step of a) detecting a predetermined motion of a user who is a conference participant on the basis of a picked-up image of the user, and b) sending a send object file under the condition that the predetermined motion is detected, the send object file being selected by the user.

The present invention is still further intended for a non-transitory computer-readable recording medium. According to a fifth aspect of the present invention, the non-transitory computer-readable recording medium records therein a program for causing a computer to perform the steps of a) detecting a predetermined motion of a user who is a conference participant on the basis of a picked-up image of the user, and b) sending a send object file under the condition that the predetermined motion is detected, the send object file being selected by the user.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a system configuration diagram showing an outline of a conference system;

FIG. 2 is a conceptual diagram showing how it is like in a conference room;

FIG. 3 is a view showing a hardware structure of a conference management apparatus;

FIG. 4 is a block diagram showing a functional constitution of the conference management apparatus;

FIG. 5 is a view showing a hardware structure of a mobile data terminal;

FIG. 6 is a block diagram showing a functional constitution of the mobile data terminal;

FIG. 7 is a flowchart showing an operation of the mobile data terminal;

FIGS. 8 and 9 are flowcharts showing an operation of the conference management apparatus;

FIGS. 10 and 11 are views each showing a screen displayed on an operation panel of the mobile data terminal; and

FIGS. 12 to 17 are views each showing a picked-up image of the conference room.

### DESCRIPTION OF THE PREFERRED EMBODIMENTS

Hereinafter, the preferred embodiment of the present invention will be discussed with reference to figures.

<1. System Configuration>

<1-1. Outline>

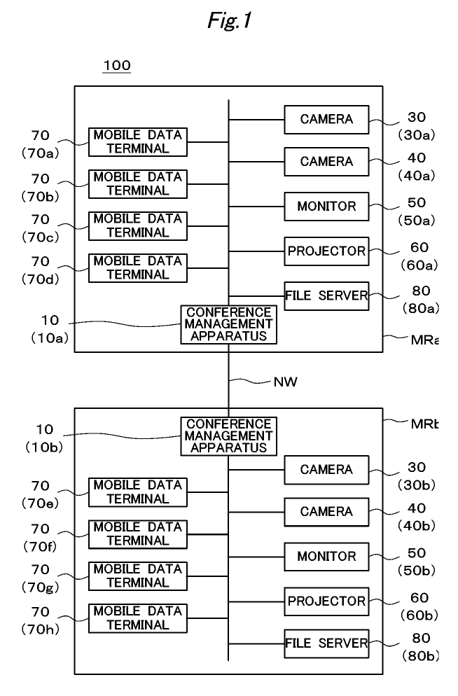

FIG. 1 is a system configuration diagram showing an outline of a conference system 100. In the conference system 100, a send object file is transmitted under the condition that a gesture of a conference participant, more specifically, a throwing gesture GT is detected.

The conference system 100 comprises two conference management apparatuses 10 (10a and 10b).

The conference management apparatus 10a and the conference management apparatus 10b are (remotely) located at sites (remote sites) distant from each other. For example, one conference management apparatus 10a is located in a conference room MRa in Osaka and the other conference management apparatus 10b is located in a conference room MRb in Tokyo.

The conference system 100 further comprises a plurality of cameras (image pickup apparatuses) 30 and 40 (in detail, cameras 30a, 30b, 40a, and 40b).

The plurality of cameras 30 and 40 pick up moving images (in detail, moving images including users who are conference participants) in a conference. In this case, provided are four cameras 30a, 30b, 40a, and 40b. The cameras 30a and 40a are placed in the conference room MRa and the cameras 30b and 40b are placed in the conference room MRb.

The conference system 100 further comprises a plurality of display-output equipments 50 and 60 (in detail, monitors 50a and 50b and projectors 60a and 60b).

The monitor 50 placed at one site displays the moving image obtained by the camera 30 placed at the other site. In this case, provided are two monitors 50a and 50b. The monitor 50a is placed in the conference room MRa and displays the moving image obtained by the camera 30b placed at the other site (in the conference room MRb). On the other hand, the monitor 50b is placed in the conference room MRb and displays the moving image obtained by the camera 30a placed at the other site (in the conference room MRa).

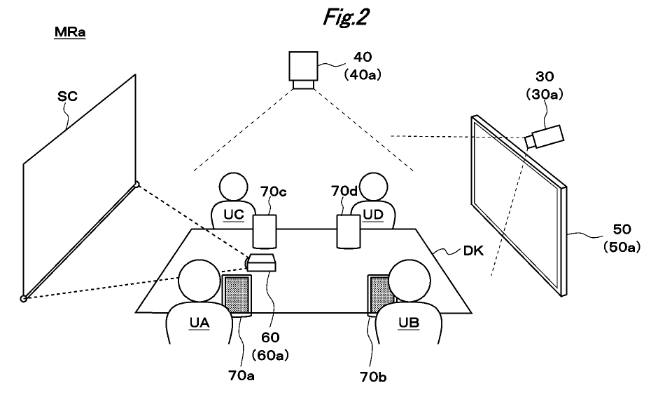

The projector 60 projects (displays) an image based on a file (relevant to a conference material) which is transmitted via a network NW onto a screen SC (see FIG. 2). In this case, provided are two projectors 60a and 60b. The projector 60a is placed in the conference room MRa and the projector 60b is placed in the conference room MRb.

The conference system 100 further comprises a plurality of mobile data terminals 70 (70a to 70d and 70e to 70h) and file servers 80 (80a and 80b).

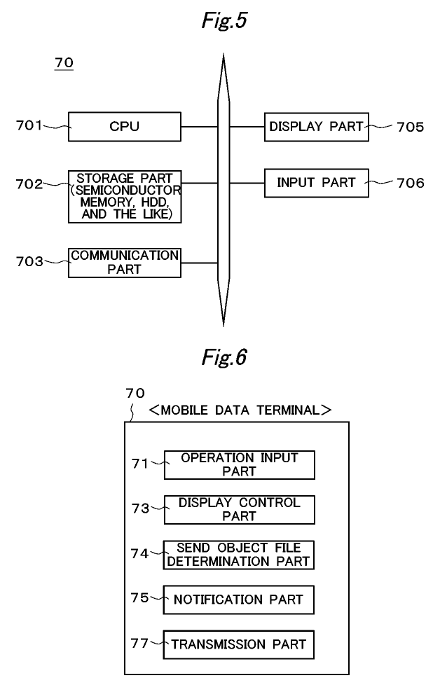

As the mobile data terminals 70, a variety of devices such as mobile personal computers, personal data assistant terminals (PDA devices), cellular phones, and the like can be used. The mobile data terminals 70 (70a to 70d and 70e to 70h) are provided for a plurality of users (UA to UD and UE to UH), respectively. The plurality of mobile data terminals 70 each have a display part (a liquid crystal display part or the like) 705 (see FIG. 5). Each of the mobile data terminals 70 displays the file transmitted via the network NW onto the display part 705.

The file server 80 temporarily stores therein the send object file transmitted from the mobile data terminal 70 or the like. The file server 80a is placed in the conference room MRa and the file server 80b is placed in the conference room MRb.

The conference management apparatus 10, the plurality of cameras 30 and 40, the plurality of display-output equipments 50 and 60, the plurality of mobile data terminals 70, and the file server 80 are connected to one another via the network NW and capable of performing network communication. Herein, the network NW includes a LAN, a WAN, the internet, and the like. The connection between each of the above devices and the network NW may be wired or wireless.

FIG. 2 is a conceptual diagram showing how it is like in one conference room MRa. Hereinafter, the constitution of the conference system 100 will be discussed in more detail with reference to FIG. 2. Though the conference room MRa is taken as an example herein, the other conference room MRb has the same arrangement as that of the conference room MRa.

As shown in FIG. 2, in the conference room MRa, four conference participants (the users UA to UD) participate in a conference. The users UA to UD have the mobile data terminals 70a to 70d, respectively. Further in the conference room MRa, provided are the camera 30 (30a), the camera 40 (40a), the monitor 50 (50a), the projector 60 (60a), the screen SC, and the like.

The camera 30 (30a) is disposed near the center position in the upper side of the monitor 50 (50a). The camera 30a picks up images of a certain range including the users UA to UD from diagonally upward.

The camera 40 (40a) is disposed over a conference desk DK (herein, on the ceiling of the room). The camera 40a picks up images of a certain range including the users UA to UD (see FIG. 12) from directly above.

The monitor 50 (50a) is disposed on the right side viewed from the users UA and UB (on the left side viewed from the users UC and UD). The monitor 50a displays a moving image showing how the conference is conducted at the other site, which is obtained by the camera 30b provided in the other conference room MRb.

The projector 60 (60a) is disposed on the conference desk DK. The projector 60a projects various images onto the screen SC which is disposed on the left side viewed from the users UA and UB (on the right side viewed from the users UC and UD).

<1-2. Conference Management Apparatus 10>

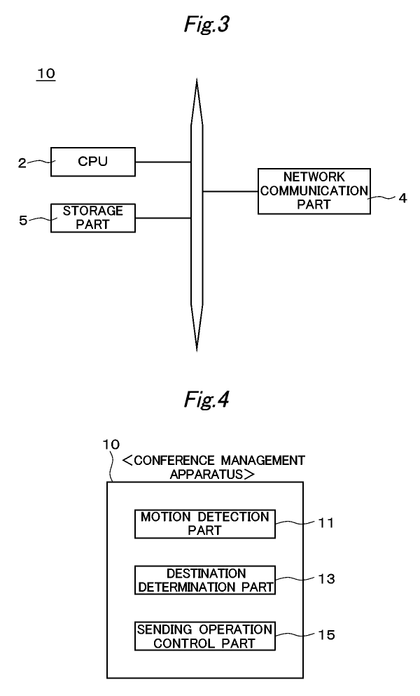

FIG. 3 is a view showing a hardware structure of the conference management apparatus (10a, 10b). As shown in FIG. 3, the conference management apparatus 10 comprises a CPU 2, a network communication part 4, and a storage part 5 (a semiconductor memory, a hard disk drive (HDD), or/and the like). The conference management apparatus 10 uses the CPU 2 and the like to execute a program PG1, thereby implementing various functions. The program PG1 is recorded in any one of various portable recording media (in other words, various non-transitory computer-readable recording media) such as a CD-ROM, a DVD-ROM, a USB memory, and the like and installed into the conference management apparatus 10 via the recording medium.

FIG. 4 is a block diagram showing a functional constitution of the conference management apparatus 10. As shown in FIG. 4, the conference management apparatus 10 comprises a motion detection part 11, a destination determination part 13, a sending operation control part 15, and the like.

The motion detection part 11 is a processing part for detecting a predetermined motion (the throwing gesture GT) of a conference participant on the basis of the moving image (picked-up image) MV (MV1, MV2) obtained by the camera (40a, 40b). The motion detection part 11 also detects a throwing direction of the throwing gesture GT on the basis of the moving image MV. An operation of detecting the throwing gesture GT and an operation of detecting the throwing direction of the throwing gesture GT will be discussed later in detail.

The destination determination part 13 is a processing part for determining a destination (send target) of the send object file in accordance with the throwing direction of the throwing gesture GT.

The sending operation control part 15 is a processing part for controlling an operation of sending the send object file.

<1-3. Mobile Data Terminal 70>

FIG. 5 is a view showing a hardware structure of the mobile data terminal 70 (70a to 70h).

As shown in FIG. 5, the mobile data terminal 70 comprises a CPU 701, a storage part 702 (a semiconductor memory (RAM or the like), a hard disk drive (HDD), or/and the like) 702, a communication part 703, a display part 705, and an input part 706.

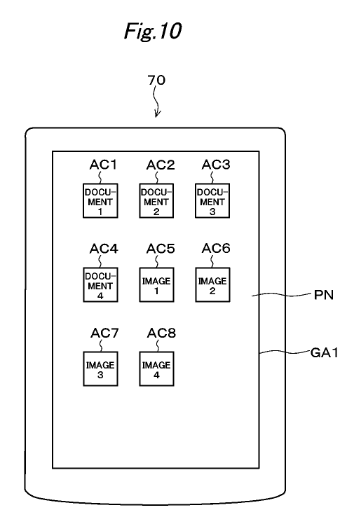

The mobile data terminal 70 has an operation panel (a liquid crystal touch screen or the like) PN (see FIG. 10) having both the function as the display part 705 (display function) and the function as the input part 706 (operation input function). The mobile data terminal 70 can provide the users with various information by displaying the information on the operation panel PN and also receive operation inputs from the users through the operation panel PN.

The mobile data terminal 70 further stores various files FL (FL1 to FL8) relevant to the conference into the storage part 702. Various files FL include, for example, document files, image files, and the like. Herein, as an example, taken is a case where the files FL1 to FL4 are document files and the files FL5 to FL8 are image files.

Further, the mobile data terminal 70 uses the CPU 701 and the like to execute a program PG2, thereby implementing various functions. The program PG2 is recorded in any one of various portable recording media (a USB memory and the like) and installed into the mobile data terminal 70 via the recording medium. The mobile data terminal 70 has a function of reading various portable recording media (a USB memory and the like).

FIG. 6 is a functional block diagram showing processing parts implemented in the mobile data terminal 70 by executing the program PG2.

Specifically, the mobile data terminal 70 comprises an operation input part 71, a display control part 73, a send object file determination part 74, a notification part 75, and a transmission part 77. The operation input part 71 is a processing part for receiving an operation input from a user. The display control part 73 is a processing part for controlling a content to be displayed on the operation panel PN. The send object file determination part 74 is a processing part for determining a send object file. The notification part 75 is a processing part for giving a selection notification on the send object file and notifying a file pass, a file name, and the like (hereinafter, referred to as “file information FI”) relating to the send object file. The transmission part 77 is a processing part for transmitting the send object file to a designated destination.

<2. Operation>

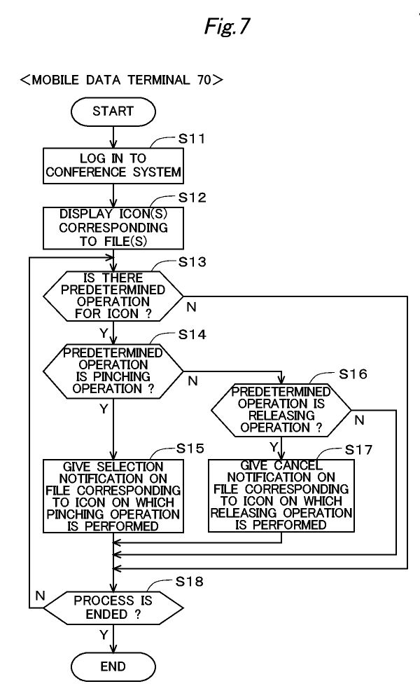

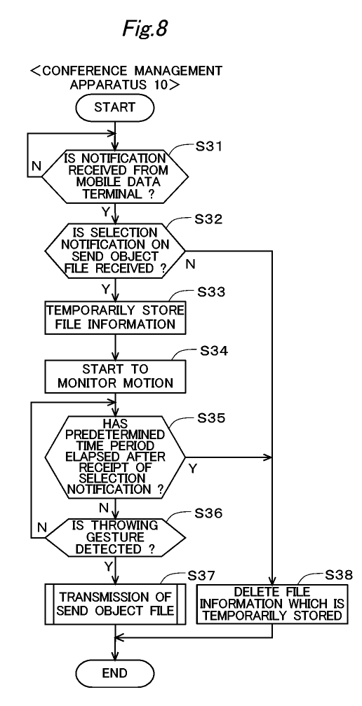

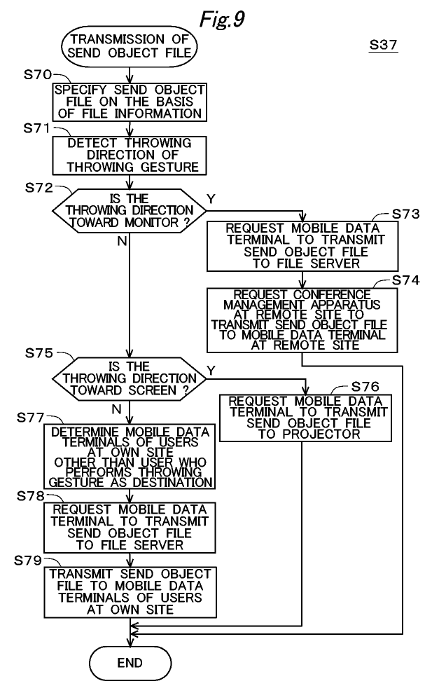

Next, discussion will be made on operations of the conference system 100, with reference to the flowcharts of FIGS. 7 to 9. FIG. 7 is a flowchart showing an operation of the mobile data terminal 70. FIGS. 8 and 9 are flowcharts showing an operation of the conference management apparatus 10.

Hereafter, as an example, taken is a case where a user UA who is a participant of a conference and present in the conference room MRa performs a predetermined motion (the throwing gesture GT) and a send object file which is selected in advance is thereby sent. For convenience of discussion, the conference room MRa is also referred to as an own site (where the user UA is present) and the other conference room MRb is also referred to as the other site (remote site). Further, the conference participants (users UA to UD) present in the conference room MRa are also referred to as the users at the own site and the conference participants (users UE to UH) present in the conference room MRb are also referred to as the users at the remote site.

<2-1. Mobile Data Terminal 70>

First, discussion will be made on an operation of the mobile data terminal 70 (70a), with reference to the flowchart of FIG. 7.

In Step S11, first, the mobile data terminal 70a performs a predetermined authentication operation in accordance with an operation input from the user, to thereby log in to the conference system 100. At this point in time, it is assumed that the mobile data terminals 70b to 70d and 70e to 70h other than the mobile data terminal 70a have already performed the authentication operation to log in to the conference system 100.

In Step S12, the mobile data terminal 70 displays a selection screen GA1 (see FIG. 10) used for selecting a send object file on the operation panel PN in accordance with the operation input from the user. As shown in FIG. 10, for example, eight icons AC1 to AC8 corresponding to the eight files FL1 to FL8 are displayed in the selection screen GA1. This is, however, only one exemplary display, and in another exemplary case where only one file FL1 is stored in the storage part 702, the icon AC1 corresponding to the file FL1 may be displayed alone in the selection screen GA1.

In Step S13, it is determined whether or not an operation input for each of the icons AC (AC1 to AC8) from the user is received. When it is determined that the operation input is received, the process goes to Step S14, and otherwise the process goes to Step S18.

In Step S18, it is determined whether to end the operation of selecting a send object file. When the operation of selecting a send object file is determined to be ended, the selection screen GA1 is closed and the operation of selecting a send object file is ended, and otherwise the process goes back to Step S13.

In Step S14, it is determined whether or not the operation input from the user is a “pinching operation” (discussed below). When it is determined that the operation input is the “pinching operation”, the process goes to Step S15, and otherwise the process goes to Step S16.

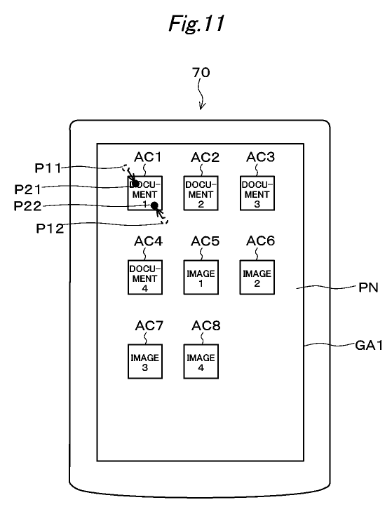

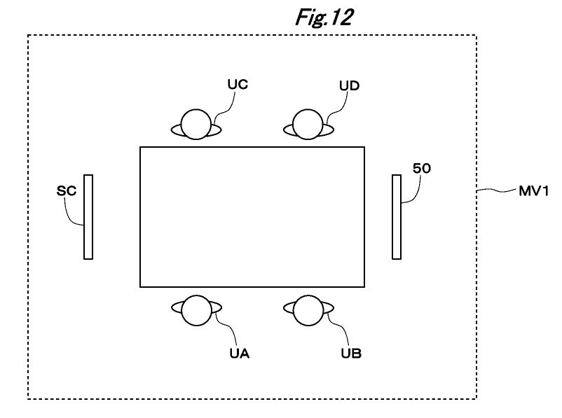

Herein, with reference to FIG. 11, the “pinching operation” for the icon AC1 (to be selected) will be discussed. First, the user UA touches the outside (for example, positions P11 and P12 in FIG. 11) of the icon AC1 by two fingers. Then, the user UA gradually narrows the distance of the two fingers while keeping the two fingers in touch with the screen. Finally, the user UA moves the two fingers onto the icon AC1 (for example, positions P21 and P22 in FIG. 11). Thus, when the pinching operation by the two fingers of the user UA (hereinafter, referred to simply as a “pinching operation”) is performed on the icon AC1, the send object file determination part 74 selects the file FL1 corresponding to the icon AC1 as the send object file.

In Step S15, the mobile data terminal 70 uses the notification part 75 to notify the conference management apparatus 10 that the file corresponding to the icon on which the “pinching operation” is performed is selected as the send object file (in other words, to give the conference management apparatus 10 a selection notification). When the selection notification is given, the notification part 75 also notifies the conference management apparatus 10 of the file information FI (discussed below) of the send object file. The file information FI is information including the file name, the file pass, and the like of the send object file.

On the other hand, in Step S16, it is determined whether or not the operation input from the user is a “releasing operation” (discussed below). When it is determined that the operation input is the “releasing operation”, the process goes to Step S17, and otherwise the process goes to Step S18.

Herein, the “releasing operation” for the icon AC1 (selected) will be discussed. First, the user UA touches the icon AC1 (for example, the positions P21 and P22 in FIG. 11) corresponding to the file FL1 which is selected as the send object file, by two fingers. Then, the user UA gradually widens the distance of the two fingers toward the outside of the icon AC1 while keeping the two fingers in touch with the screen. Finally, the user UA moves the two fingers to the outside of the icon AC1 (for example, the positions P11 and P12 in FIG. 11). Thus, when the operation of widening the distance of the two fingers of the user UA (the operation of making the two fingers away from each other) (hereinafter, referred to simply as a “releasing operation”) is performed on the icon AC1, the send object file determination part 74 cancels the determination of the file FL1 corresponding to the icon AC1 as the send object file.

In Step S17, the mobile data terminal 70 uses the notification part 75 to notify the conference management apparatus 10 that the selection of the file corresponding to the icon on which the “releasing operation” is performed, as the send object file, is canceled (in other words, to give the conference management apparatus 10 a cancel notification).

<2-2. Conference Management Apparatus 10 (10a)>

Next, discussion will be made on an operation of the conference management apparatus 10 (herein, 10a), with reference to the flowcharts of FIGS. 8 and 9.

In Step S31, first, it is determined whether or not a notification (a selection notification or a cancel notification on the send object file) from the mobile data terminal 70 is received. When it is determined that the notification from the mobile data terminal 70 is received, the process goes to Step S32.

In Step S32, it is determined whether or not the notification from the mobile data terminal 70 is the selection notification on the send object file. When it is determined that the notification from the mobile data terminal 70 is the selection notification on the send object file, the process goes to Step S33. On the other hand, when it is not determined that the notification from the mobile data terminal 70 is the selection notification on the send object file, it is determined that the notification is the cancel notification on the send object file and the process goes to Step S38.

In Step S33, the conference management apparatus 10a temporarily stores the file information FI (the file pass, the file name, and the like) received when the selection notification on the send object file is given, into the storage part 5.

In Step S34, the conference management apparatus 10a starts to pick up a moving image MV1 including the users UA to UD (see FIG. 12) by using the camera 40 and also starts to monitor whether or not a predetermined motion (the throwing gesture GT) occurs, by using the motion detection part 11.

In Step S35, it is determined whether or not a predetermined time period (for example, one minute) has elapsed after the receipt of the selection notification. When it is determined that the predetermined time period has elapsed, the process goes to Step S38, and otherwise the process goes to Step S36.

In Step S38, the conference management apparatus 10a deletes the file information FI which is temporarily stored in the storage part 5.

In Step S36, it is determined whether or not the predetermined motion (in detail, the throwing gesture GT) is detected by the motion detection part 11 in the conference management apparatus 10a. When it is determined that the throwing gesture GT is detected, the process goes to Step S37, and otherwise the process goes back to Step S35.

Herein, discussion will be made, with reference to FIGS. 12 to 14, on an operation of detecting the throwing gesture GT. In this case, it is assumed that the users UA to UD are informed in advance that a throwing gesture GT by the right arm is to be detected and therefore the users UA to UD will perform a throwing gesture GT by the right arm. It is further assumed that the user UA who has selected the icon AC by the above-discussed “pinching operation” is to perform the throwing gesture GT and the conference management apparatus 10 is to detect the throwing gesture GT by the right arm of the user UA.

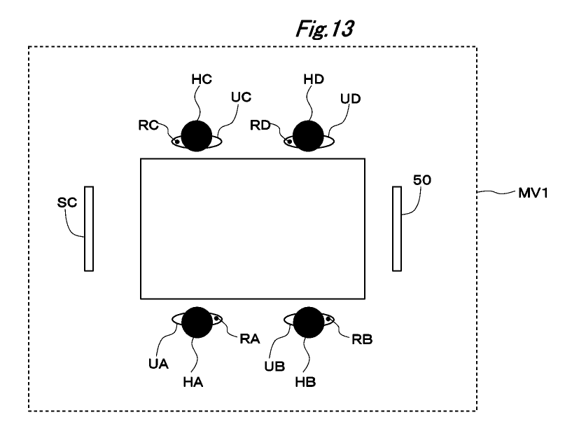

First, when the camera 40a starts to pick up the moving image MV1 (see FIG. 12) (Step S34), the motion detection part 11 detects respective heads HA to HD of the users UA to UD on the basis of the moving image MV1 (see FIG. 13).

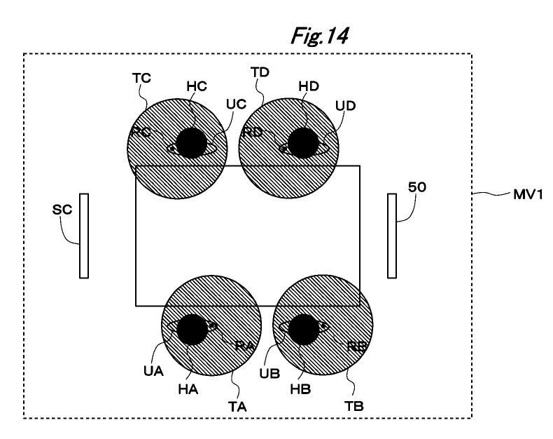

Having detected the heads HA to HD, the motion detection part 11 detects positions RA to RD away from the substantial centers of the heads HA to HD toward the right side by a predetermined distance (for example, about 20 cm in terms of a real space distance) (see FIG. 13) as the positions of right shoulders of the users UA to UD, respectively. Then, the motion detection part 11 monitors respective surrounding areas TA to TD of the positions RA to RD (see FIG. 14). The surrounding areas TA to TD are areas of circles having a radius of, for example, about 70 cm in terms of the real space distance with the positions RA to RD as their centers.

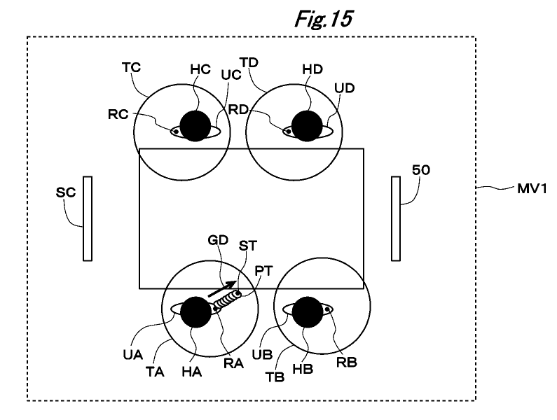

While the moving image MV1 is monitored, when an extending portion PT (see FIG. 15) which extends from near one of the positions RA to RD (for example, the position RA) toward one direction is detected within a predetermined time period (for example, one second), it is determined whether or not the length of the extending portion PT in the extending direction is not shorter than a predetermined value (for example, 50 cm in terms of the real space distance). When it is determined that the length of the extending portion PT in the extending direction is not shorter than the predetermined value, the motion detection part 11 determines that the throwing gesture GT is performed. Then, the process goes to Step S37.

In Step S37, the conference management apparatus 10a performs a process of transmitting the send object file. Specifically, the conference management apparatus 10a performs the operation of the flowchart in FIG. 9.

Next, with reference to FIG. 9, the process of transmitting the send object file will be discussed.

In Step S70, first, the sending operation control part 15 specifies the send object file on the basis of the file information FI (the file pass, the file name, and the like) which is temporarily stored in the storage part 5.

In Step S71, the conference management apparatus 10a uses the motion detection part 11 to detect the throwing direction of the throwing gesture GT. Specifically, the motion detection part 11 detects the throwing direction GD of the throwing gesture GT (see FIG. 15) on the basis of the extension start position RA (the position RA of the right shoulder of the user UA) of the extending portion PT and the end position ST of the extending portion PT at the time when the extending portion PT extends most. For example, the motion detection part 11 detects the direction of a vector toward the end position ST from extension start position RA as the throwing direction GD.

In Step S72, it is determined whether or not the throwing direction GD of the throwing gesture GT is a direction DC. The direction DC is a direction toward a location of the monitor 50a (in detail, a display surface displaying an output image from the monitor 50a) from a location of the user UA.

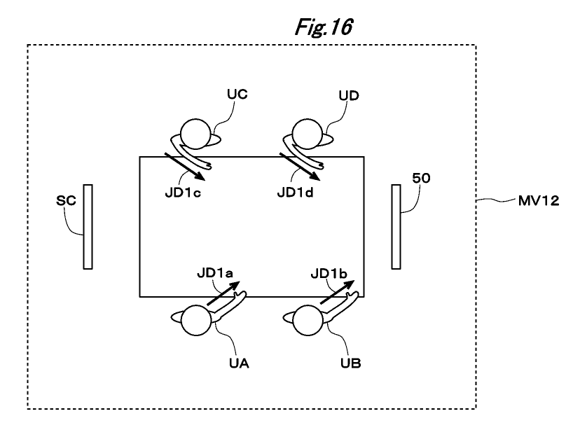

In determination on whether the throwing direction GD is the direction DC or not, a direction JD1 for determination, discussed later, is used. Specifically, when the difference between the throwing direction GD and the direction JD1 for determination is smaller than a predetermined value, the throwing direction GD is determined to be the direction DC. On the other hand, when the difference between the throwing direction GD and the direction JD1 for determination is not smaller than the predetermined value, the throwing direction GD is not determined to be the direction DC. The directions JD1 (JD1a to JD1d) for determination are detected from the throwing gestures GT which the users UA to UD perform in advance (before the conference). Specifically, as shown in FIG. 16, the users UA to UD each perform the throwing gesture GT toward the monitor 50 at the same time. The conference management apparatus 10a calculates the respective directions JD1a to JD1d for determination, for the users UA to UD, on the basis of a moving image MV12 of the throwing gestures GT obtained by the camera 40a.

In such determination, when it is determined that the throwing direction GD is the direction DC, the destination determination part 13 determines the mobile data terminals 70e to 70h of the users UE to UH at the remote site as the destinations (send targets) of the send object file. Thus, the destination determination part 13 determines the mobile data terminals 70e to 70h of the users UE to UH who are conference participants at the remote site (in the conference room MRb) as the destinations under the condition that the throwing direction GD of the throwing gesture GT is the direction DC. Then, the process goes to Step S73. On the other hand, when it is not determined that the throwing direction GD is the direction DC, the process goes to Step S75.

In Step S73, the sending operation control part 15 gives the mobile data terminal 70 a request for transmission (transmission request) of the send object file to the file server 80a. In response to the transmission request from the conference management apparatus 10a, the mobile data terminal 70 transmits the send object file to the file server 80a.

In Step S74, the sending operation control part 15 gives the conference management apparatus 10b at the remote site a request for transmission (transmission request) of the send object file stored in the file server 80a to the users UE to UH at the remote site. In response to the transmission request from the conference management apparatus 10a, the conference management apparatus 10b at the other site makes access to the file server 80a to acquire the send object file and transmits the send object file to the mobile data terminals 70e to 70h of the users UE to UH.

Thus, the sending operation control part 15 of the conference management apparatus 10a uses the conference management apparatus 10b at the other site and the like to transmit the send object file to the mobile data terminals 70e to 70h of the users UE to UH at the other site.

In Step S75, it is determined whether or not the throwing direction of the throwing gesture GT is a direction DB. The direction DB is a direction toward a location of the screen SC (the display surface displaying the output image from the projector 60) from the location of the user UA.

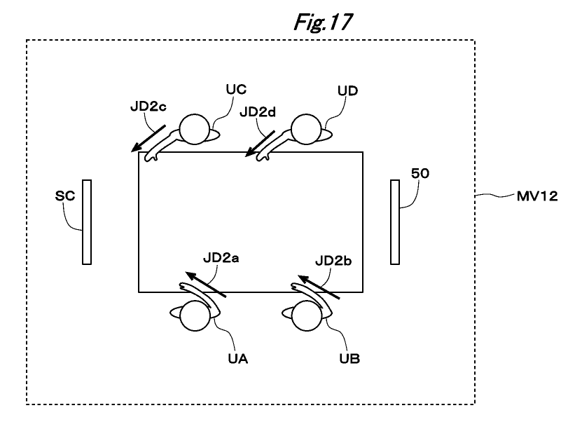

In determination on whether the throwing direction GD is the direction DB or not, a direction JD2 for determination, discussed later, is used. Specifically, when the difference between the throwing direction GD and the direction JD2 for determination is smaller than a predetermined value, the throwing direction GD is determined to be a direction toward the location of the screen SC (i.e., the direction DB). On the other hand, when the difference between the throwing direction GD and the direction JD2 for determination is not smaller than the predetermined value, the throwing direction GD is not determined to be the direction DB. The directions JD2 (JD2a to JD2d) for determination are detected from the throwing gestures GT performed in advance (before the conference). Specifically, as shown in FIG. 17, the users UA to UD each perform the throwing gesture GT toward the screen SC at the same time. The conference management apparatus 10a calculates the respective directions JD2a to JD2d for determination, for the users UA to UD, on the basis of the moving image MV12 of the throwing gestures GT obtained by the camera 40a.

In such determination, when it is determined that the throwing direction GD is the direction DB, the destination determination part 13 determines the projector 60a as the destination (send target) of the send object file. Thus, the destination determination part 13 determines the projector 60a as the destination under the condition that the throwing direction GD of the throwing gesture GT is the direction DB. Then, the process goes to Step S76. On the other hand, when it is not determined that the throwing direction GD is the direction DB, the process goes to Step S77.

In Step S76, the sending operation control part 15 gives the mobile data terminal 70 a request for transmission (transmission request) of the send object file to the projector 60a. In response to the transmission request from the conference management apparatus 10a, the mobile data terminal 70 transmits the send object file to the projector 60a. Then, the projector 60 projects and displays an output image (display image) based on the send object file received by the mobile data terminal 70 onto the screen SC.

Thus, the conference management apparatus 10a uses the sending operation control part 15 to transmit the send object file to the projector 60a.

In Step S77, the destination determination part 13 determines the mobile data terminals 70b to 70d of the conference participants (users UB to UD) at the own site other than the user UA as the destinations of the send object file. The present preferred embodiment is based on the premise that the throwing direction GD is one of the three directions DA, DB, and DC. When the throwing direction GD is neither the direction DC nor the direction DB, the throwing direction GD is assumed to be a direction DA toward a location of one of the plurality of conference participants (users UA to UD) at the own site. The destination determination part 13 determines all the mobile data terminals 70b to 70d of the conference participants (users UB to UD) at the own site other than the user UA as the destinations of the send object file under the condition that the throwing direction GD is the direction DA (in detail, the throwing direction GD is regarded as the direction DA).

In Step S78, the sending operation control part 15 gives the mobile data terminal 70 a request for transmission (transmission request) of the send object file to the file server 80a. In response to the transmission request from the conference management apparatus 10a, the mobile data terminal 70 transmits the send object file to the file server 80a.

In Step S79, the sending operation control part 15 transmits the send object file stored in the file server 80a to the mobile data terminals 70b to 70d of the users UB to UD at the own site other than the user UA who performs the throwing gesture GT.

Thus, the conference management apparatus 10a uses the sending operation control part 15 to transmit the send object file to the users UB to UD at the own site other than the user UA.

Through the above operation, the send object file is transmitted under the condition that the throwing gesture GT of the user UA is detected on the basis of the moving image MV1 obtained by the camera 40a. Therefore, it is possible to provide a more user-friendly user interface. Further, the user UA can give an instruction to transmit the send object file by an intuitive operation such as throwing in the real space.

Since the destination of the send object file is determined in accordance with the throwing direction of the throwing gesture GT, the user can more easily indicate the destination as compared with a case where the destination is determined from a destination list or the like which is displayed on a predetermined screen.

Further, since the file corresponding to the icon AC receiving the pinching operation is determined as the send object file, the user can intuitively give an instruction to transmit the send object file by a series of motions such as pinching of the icon AC and throwing.

Under the condition that the throwing direction GD of the throwing gesture GT is the direction DC (the direction toward the location of the monitor 50a from the location of the user UA), the mobile data terminals 70e to 70h of the users UE to UH at the remote site, who are conference participants present in the conference room MRb (at the other site) are determined as the destinations of the send object file. Therefore, the user can determine the mobile data terminals 70e to 70h of the users UE to UH at the other site as the destinations of the send object file by performing the throwing gesture GT toward the monitor 50a on which an image showing how it is like in the conference room MRb (at the other site) is displayed. Accordingly, the user can intuitively recognize, by the throwing gesture GT toward the direction DC, that the destination of the send object file is determined to be the mobile data terminals 70e to 70h of the users UE to UH at the other site.

Further, under the condition that the throwing direction GD of the throwing gesture GT is the direction DB (the direction toward the location of the screen SC from the location of the user UA), the projector 60a is determined as the destination of the send object file. Therefore, the user can determine the projector 60a as the destination of the send object file by performing the throwing gesture GT toward the screen SC on which an image based on the file relevant to the conference material is displayed (projected). Accordingly, the user can intuitively recognize, by the throwing gesture GT toward the direction DB, that the destination of the send object file is determined to be the projector 60a.

Furthermore, under the condition that the throwing direction GD of the throwing gesture GT is the direction DA (in detail, the throwing direction GD is regarded as the direction DA), all the mobile data terminals 70b to 70d of the conference participants (the users UB to UD) at the own site other than the user UA are determined as the destinations of the send object file. Therefore, the user UA can determine the mobile data terminals 70b to 70d of the users UB to UD as the destinations of the send object file by performing the throwing gesture GT toward the one of the plurality of conference participants (herein, the users UB to UD) at the own site where the user UA is present. Accordingly, the user can intuitively recognize, by the throwing gesture GT toward the direction DA, that the destination of the send object file is determined to be the mobile data terminals 70b to 70d.

<3. Variations>

Though the preferred embodiment of the present invention has been discussed above, the present invention is not limited to the above-discussed cases.

For example, though any one of the icons AC1 to AC8 is selected by the “pinching operation” (see FIG. 11) in the above-discussed preferred embodiment, this is only one exemplary case, and the icon may be selected by other operations (for example, a tapping operation).

Though the mobile data terminal 70 has the operation panel PN having both the function as the display part 705 and the function as the input part 706 in the above-discussed preferred embodiment, this is only one exemplary case, and the mobile data terminal 70 may separately have a liquid crystal display having the function as the display part 705 and a keyboard and a mouse having the function as the input part 706.

Though the cameras 30 and 40 and the projector 60 are connected to the conference management apparatus 10 via the network NW in the above-discussed preferred embodiment, this is only one exemplary case, and these devices may be directly connected to the conference management apparatus 10. In such a case, a picked-up image (video signals or the like) may be inputted to the conference management apparatus 10 through a video signal input part (in detail, an external input terminal) of the conference management apparatus 10.

In the case where the projector 60a is directly connected to the conference management apparatus 10a, the sending operation control part 15 may transmit the send object file to the conference management apparatus 10a which controls the display output of the projector 60a, without transmitting the send object file to the projector 60a by using the mobile data terminal 70a. Then, the conference management apparatus 10a may transmit output image data based on the send object file to the projector 60a.

Though the case has been discussed where the mobile data terminals 70b to 70d of the conference participants (the users UB to UD) at the own site other than the user UA are determined as the destinations of the send object file in the above-discussed preferred embodiment, this is only one exemplary case. For example, the mobile data terminals 70a to 70d of all the conference participants (the users UA to UD) including the user UA may be determined as the destinations of the send object file. Even in a case where there are two conference participants (for example, the users UA and UB) at the own site, similarly, both the mobile data terminal 70a of the user UA and the mobile data terminal 70b of the user UB may be determined as the destinations of the send object file. Alternatively, only the mobile data terminal 70b of the conference participant (the user UB) at the own site other than the user UA may be determined as the destination of the send object file.

Though the case has been discussed where an image showing how the conference is conducted in the conference room MRb (at the remote site) is displayed on the monitor 50a in the conference room MRa (at the own site) and the image based on the file relevant to the conference material is projected on the screen SC by the projector 60a at the own site in the above-discussed preferred embodiment, this is only one exemplary case. For example, there may be a converse case where the image showing how the conference is conducted in the conference room MRb (at the remote site) is projected on the screen SC by the projector 60a in the conference room MRa (at the own site) and the image based on the file relevant to the conference material is displayed on the monitor 50a at the own site.

In this case, the destination determination part 13 has only to determine the monitor 50a as the destination under the condition that the throwing direction of the throwing gesture GT is the direction DC. Further, the destination determination part 13 has only to determine the mobile data terminals 70e to 70h of the users UE to UH who are the conference participants in the conference room MRb (at the other site) as the destinations under the condition that the throwing direction of the throwing gesture GT is the direction DB.

Though the case has been discussed where the mobile data terminals 70e to 70h of the users UE to UH who are the conference participants in the conference room MRb (at the remote site) are determined as the destinations under the condition that the throwing direction of the throwing gesture GT is the direction DC in the above-discussed preferred embodiment, this is only one exemplary case. For example, the projector 60b at the remote site may be determined as the destination under the condition that the throwing direction of the throwing gesture GT is the direction DC. In this case, the users UA to UD at the own site can project the image relevant to the send object file onto the screen at the other site (remote site) by using the projector 60b.

Further though the case has been discussed where the eight icons AC1 to AC8 corresponding to the eight files FL1 to FL8 are displayed on the operation panel PN in the above-discussed preferred embodiment, this is only one exemplary case, and icons AF (for example, AF1 to AF4) corresponding to folders FD (for example, FD1 to FD4) having one or a plurality of files may be displayed. In this case, if a pinching operation for the icon AF1 is received, the send object file determination part 74 has only to determine all the files in the folder FD1 corresponding to the icon AF1 as the send object file.

While the invention has been shown and described in detail, the foregoing description is in all aspects illustrative and not restrictive. It is therefore understood that numerous modifications and variations can be devised without departing from the scope of the invention.

What is claimed is:

1. A conference system, comprising:
an operation input part for receiving an operation input for selecting a send object file, which is given by a user who is a conference participant;
an image pickup part for picking up an image of said user;
a motion detection part for detecting a predetermined motion of said user on the basis of a picked-up image obtained by said image pickup part; and
a sending operation control part for sending said send object file under the condition that said predetermined motion is detected.

2. The conference system according to claim 1, wherein
said predetermined motion includes a throwing gesture.

3. The conference system according to claim 2, further comprising:
a destination determination part for determining a destination of said send object file,
wherein said motion detection part detects a throwing direction of said throwing gesture on the basis of said picked-up image, and
said destination determination part determines a destination of said send object file in accordance with said throwing direction.

4. The conference system according to claim 3, being a system for conducting a conference among a plurality of sites, wherein
said plurality of sites include a first site which is a site where said user is located and a second site other than said first site, and
said destination determination part determines a terminal of at least one of conference participants at said first site as said destination under the condition that said throwing direction is a first direction.

5. The conference system according to claim 4, wherein
said first direction is a direction from a location of said user toward a location of one of a plurality of conference participants at said first site.

6. The conference system according to claim 3, further comprising:
a first display-output part,
wherein said destination determination part determines said first display-output part as said destination under the condition that said throwing direction is a second direction.

7. The conference system according to claim 3, further comprising:
a first display-output part,
wherein said destination determination part determines an apparatus for controlling a display output of said first display-output part as said destination under the condition that said throwing direction is a second direction.

8. The conference system according to claim 6, wherein
said second direction is a direction from a location of said user toward a location of a display surface displaying an output image from said first display-output part.

9. The conference system according to claim 3, being a system for conducting a conference among a plurality of sites, wherein
said plurality of sites include a first site which is a site where said user is located and a second site other than said first site, and
said destination determination part determines a terminal of a conference participant at said second site as said destination under the condition that said throwing direction is a third direction.

10. The conference system according to claim 9, further comprising:
a second display-output part for outputting an image showing how a conference is conducted at said second site, and
said third direction is a direction from a location of said user toward a location of a display surface displaying an output image from said second display-output part.

11. The conference system according to claim 1, further comprising:
a third display-output part for displaying one or a plurality of icons corresponding to one or a plurality of files or one or a plurality of folders, respectively; and
a send object file determination part for determining said send object file,
wherein said operation input part receives a selecting operation using said one or plurality of icons, and
said send object file determination part determines a file corresponding to a selected icon which is selected out of said one or plurality of icons as said send object file.

12. The conference system according to claim 2, further comprising:
a third display-output part for displaying one or a plurality of icons corresponding to one or a plurality of files or one or a plurality of folders, respectively; and
a send object file determination part for determining said send object file,
wherein said operation input part receives an operation of pinching an icon to be selected out of said one or plurality of icons by fingers of said user, and
said send object file determination part determines a file corresponding to said icon to be selected as said send object file.

13. A conference system, comprising:
a mobile data terminal;
a conference management apparatus capable of communicating with said mobile data terminal; and
an image pickup apparatus for picking up an image of a user who is a conference participant,
wherein said mobile data terminal has:
an operation input part for receiving an operation input for selecting a send object file, which is given by said user, and
said conference management apparatus has:
a motion detection part for detecting a predetermined motion of said user on the basis of a picked-up image obtained by said image pickup apparatus; and
a sending operation control part for sending said send object file under the condition that said predetermined motion is detected.

14. A conference management apparatus, comprising:
a motion detection part for detecting a predetermined motion of a user who is a conference participant on the basis of a picked-up image of said user; and
a sending operation control part for sending a send object file under the condition that said predetermined motion is detected, said send object file being selected by said user.

15. A method for conference management, comprising the steps of:
a) detecting a predetermined motion of a user who is a conference participant on the basis of a picked-up image of said user; and
b) sending a send object file under the condition that said predetermined motion is detected, said send object file being selected by said user.

16. A non-transitory computer-readable recording medium recording therein a program for causing a computer to perform the steps of:
a) detecting a predetermined motion of a user who is a conference participant on the basis of a picked-up image of said user; and
b) sending a send object file under the condition that said predetermined motion is detected, said send object file being selected by said user.
